(19) United States
(12) Patent Application Publication
(10) Pub. No.: US 2010/0323081 A1
(43) Pub. Date: Dec. 23, 2010

(54) FLAVOR IMPROVING AGENT

(75) Inventors: Tadayoshi Katsumata, Inashiki-gun (JP); Chikara Tokunaga, Chuo-ku (JP); Hiroko Nakakuki, Inashiki-gun (JP); Masashi Ogasawara, Inashiki-gun (JP); Yuya Watanabe, Inashiki-gun (JP)

Correspondence Address: SUGHRUE MION, PLLC, 2100 PENNSYLVANIA AVENUE, N.W., SUITE 800, WASHINGTON, DC, 20037, US

(73) Assignee: KIRIN KYOWA FOODS COMPANY, LIMITED., Shinagawa-ku, Tokyo (JP)

(21) Appl. No.: 12/745,460

(22) PCT Filed: Nov. 28, 2008
(86) PCT No.: PCT/JP2008/071629

§ 371 Date: Aug. 24, 2010

(30) Foreign Application Priority Data
Nov. 30, 2007 (JP) 2007-310330

(51) Int. Cl. A23L 1/227; A23L 2/56

(52) U.S. Cl. 426/590; 426/650

(57) ABSTRACT

The present invention relates to a method of producing a flavor improving agent, comprising heating amino acids or peptides in the presence of amino sugars or a method of improving the flavor of a food or drink with the use of the flavor improving agent. Preferably, the method of improving flavor involves the enhancement of stewed taste of a stewed food or drink. In addition, the present invention relates to a method of producing a stewed food or drink, comprising a step of adding amino sugars to a food or drink material containing amino acids or peptides followed by heat cooking. Examples of amino sugars are glucosamine and galactosamine.

### TECHNICAL FIELD

The present invention relates to a flavor improving agent, a food or drink, and a method of improving flavor.

### BACKGROUND ART

In the case of a food or drink such as stew or demi-glace sauce cooked by a step of stewing an animal raw material such as livestock meat or a plant raw material such as a vegetable (hereinafter referred to as “stewed food or drink”), the step of stewing is carried out for many hours such that tastes such as sweetness and umami are enhanced in a well-balanced manner. As a result, richness, fullness, continuity of taste, etc., which are collectively referred to as a stewed taste, are imparted to the above food or drink.

However, it takes time to industrially produce such an authentic stewed food or drink with a stewed taste, resulting in, for example, an increase in production cost. This is problematic. Also at home, it is desirable for an authentic stewed food or drink to be cooked in a short time.

In order to impart a stewed taste, fond de veau, glace de viande, and the like are added to a stewed food or drink in some cases. However, in such cases, production processes are complicated and cost-consuming.

For such reason, the development of a method for readily producing a food or drink with a stewed taste has been desired.

A chicken flavor obtained by subjecting a β-alanine derivative and amino acids to heat reaction in a solvent is known to be used for imparting flavor of soup obtained by stewing chicken meat or bones or a roasted taste obtained by sautéing the same (see Patent Document 1). However, it does not impart a sufficient stewed taste.

Patent Document 1: Japanese Published Unexamined Patent Application No. H11-215967

### DISCLOSURE OF THE INVENTION

### Problem to be Solved by the Invention

It is an object of the present invention to provide a flavor improving agent, a stewed food or drink with improved flavor, a method of producing either thereof, or a method of improving the flavor of a stewed food or drink.

### Means for Solving Problem

The present invention relates to (1) to (8) described below.

(1) A method of producing a flavor improving agent, comprising heating amino acids or peptides in the presence of amino sugars.
(2) The production method according to (1), wherein heating is carried out at 90° C. to 150° C. under conditions of pH 6 to 9.
(3) A flavor improving agent produced by the method according to (1) or (2).
(4) A stewed food or drink to which the flavor improving agent according to (3) has been added.
(5) A method of improving the flavor of a stewed food or drink, comprising adding amino sugars to a stewed food or drink containing amino acids or peptides and heating the resultant.
(6) The method according to (5), wherein the improvement of flavor indicates the enhancement of stewed taste.
(7) A method of producing a stewed food or drink, comprising a step of adding amino sugars to a food or drink material containing amino acids or peptides followed by heat cooking.
(8) A food or drink produced by the method according to (7).

### EFFECTS OF THE INVENTION

According to the present invention, a flavor improving agent, a stewed food or drink with improved flavor, a method of producing either thereof, or a method of improving the flavor of a stewed food or drink can be provided.

### BEST MODE FOR CARRYING OUT THE INVENTION

The flavor improving agent of the present invention can be produced by, for example, adding amino sugars to a food or drink material containing amino acids or peptides, mixing them if necessary, and heating amino acids or peptides in the presence of amino sugars.

Amino acids or peptides and amino sugars may coexist in water, an aqueous solution of an inorganic salt such as sodium chloride, potassium chloride, or calcium chloride, a buffer such as a phosphate buffer or a citrate buffer, alcohol such as ethanol or glycerol, or a mixture thereof.

Any amino acid can be used as long as it is an amino acid generally contained in a food or drink material. However, preferable examples thereof are: basic amino acids such as arginine, lysine, and histidine; acidic amino acids such as glutamic acid and aspartic acid; glycine; and proline. Examples of amino acids may be acid metal salts, inorganic acid salts, and organic acid salts of the above examples.

Any peptide can be used as long as it is a peptide generally contained in a food or drink material. However, preferred examples of peptides that can be used are: isolated or purified peptides such as gelatin, lactalbumin, ovalbumin, and myoglobin; and protein hydrolysates such as animal protein hydrolysate and plant protein hydrolysate.

Examples of animal proteins are proteins from fishery products, bird and animal meat, dairy products, eggs, and egg products.

Examples of plant proteins are proteins from soybeans, wheat, maize, and the like.

Animal protein hydrolysates and plant protein hydrolysates can be obtained by subjecting animal proteins and plant proteins to general hydrolysis treatment with the use of enzymes such as protein hydrolase (e.g., alcalase) or acids such as hydrochloric acid and sulfuric acid. Alternatively, commercially available products may be used.

When proteins are subjected to enzyme treatment, conditions of temperature, pH, time, and the like differ depending on enzymes. Therefore, it is preferable to carry out treatment at an optimum reaction temperature and an optimum reaction pH for a relevant enzyme.

When a protein is subjected to acid treatment, for example, a method comprising subjecting a protein to heat treatment at 85° C. to 100° C. for 0.5 to 24 hours, and preferably 2 to 5 hours, in the presence of 0.1 to 1 mol/l acid is used.

Any food or drink material can be used as a food or drink material containing amino acids or peptides as long as it contains amino acids or peptides and can be used for food or drink production. Examples thereof are fishery products, bird and animal meats, dairy products, eggs and egg products, cereals such as wheat, rice, and maize, beans such as soybeans, and root vegetables such as onion, sweet potato. In addition, microorganism cells of baker's yeast, lactobacillus, and the like or cultures thereof can be used.

Also, a variety of treated products obtained by treating the above food or drink materials in a physical, chemical, or biological manner can be used as food or drink materials. An example thereof is a hydrolysis-treated product obtained via hydrolysis treatment with an acid or enzyme.

Any amino sugar can be used as long as a hydroxyl group of sugar is substituted with an amino group. A salt of such amino sugar may be used. Examples of amino sugars are glucosamine, galactosamine, mannosamine, lactosamine, fucosamine, rhamnosamine, quinovosamine, neuraminic acid, and muramic acid and preferably glucosamine and galactosamine.

In addition, such amino groups may be derivatives substituted with an acyl group such as an acetyl group, sulfate group, or glycosyl group. For instance, examples of derivatives are N-acetyl glucosamine, N-acetyl galactosamine, N-acetyl neuraminic acid, and N-glycolylneuraminic acid.

Examples of salts of amino sugars are hydrochloride, sulfate, and phosphate.

Amino sugars may be prepared by a general method from a material containing amino sugars obtained from an animal cortex, bones, cartilage, connective tissue matrix, or body fluid, arthropod shellfish, shells, or the like. Alternatively, commercially available amino sugars may be used. A material containing amino sugars may be directly used. However, such material is preferably treated with acid or the like for use.

The amount of amino sugars that are added to amino acids or peptides is preferably 0.1 to 100 parts by weight, and more preferably 0.1 to 10 parts by weight relative to 1 part by weight of the total amount of the amino acids or amino acids-constituting peptides (hereinafter referred to as the “total amino acid amount”).

The total amino acid amount in a food or drink material can be calculated as follows. At first, peptides are hydrolyzed by adding 5 to 8 mol/l hydrochloric acid to the above food or drink material and heating the resultant at 110° C. to 120° C. for 20 to 24 hours so that they are completely degraded into amino acids.

The thus obtained hydrolysates is subjected to an amino acid analyzer to measure the weights of individual amino acids, so that the sum of the weights of the amino acids can be used as the total amino acid amount in a food or drink.

The temperature for heating amino acids or peptides in the presence of amino sugars is generally equivalent to or higher than the temperature for preparing a stewed food or drink by stewing the above food or drink material. The heating temperature is generally 90° C. to 150° C., preferably 100° C. to 140° C., and more preferably 110° C. to 130° C. The heating time differs depending on the heating temperature. However, the heating time is generally 30 minutes to 1 month, preferably 1 to 24 hours, more preferably 1 to 8 hours, and further preferably 3 to 8 hours.

The pH during heating is generally pH 6 to 9, preferably pH 6 to 8, and more preferably pH 6.5 to 8. The pH can be adjusted with the use of acid or alkali that can be used for the above food or drink such that the pH falls within the above pH range.

A heat-treated product obtained after heat treatment can be directly used as the flavor improving agent of the present invention. In addition, it is possible to further subject such product to treatment such as discoloration treatment, solid-liquid separation, condensation treatment, or drying treatment alone or in combinations thereof. The thus resultant can be used as a flavor improving agent.

The flavor improving agent of the present invention may contain different additives that can be used for a food or drink if needed. Examples of additives are: inorganic salts such as sodium chloride, potassium chloride, and calcium chloride; carboxylic acids such as fumaric acid, malic acid, tartaric acid, citric acid, and fatty acid; amino acids such as sodium glutamate, glycine, and alanine; nucleic acids such as sodium inosinate and sodium guanylate; sugars such as sucrose, glucose, and lactose; seasonings such as soy sauce, miso, livestock meat extract, poultry extract, and seafood extract; condiments such as spices and herbs; and excipients such as dextrin and various types of starches.

The flavor improving agent of the present invention may be in any form such as a liquid form, a powder form, or a granule form.

The flavor improving agent of the present invention containing various types of additives may be used as a seasoning.

With the addition of the flavor improving agent of the present invention to a stewed food or drink, it has become possible to enhance taste based on richness, fullness, continuity of taste, etc. of the stewed food or drink, which is realized by stewing a food or drink material for many hours. Specifically, the flavor improving agent of the present invention can be preferably used as a stewed taste enhancing agent that is added to a stewed food or drink in order to enhance a stewed taste.

Preferably, a stewed food or drink is a food or drink cooked by stewing an animal- or seafood-derived food or drink material, and preferably, animal-derived meat, bone, or the like. Examples thereof are demi-glace sauce, meat sauce, fond, and consomme soup.

Examples of the method of improving flavor of the present invention are a method comprising adding, as a material, the flavor improving agent of the present invention during production of a stewed food or drink, a method comprising adding the flavor improving agent to a stewed food or drink product during heat cooking, cooking with the use of a microwave, or the like, and a method comprising adding the flavor improving agent during meals.

Examples of a food or drink to which the method of improving flavor of the present invention can be applied are ham, sausage, steamed meat buns, dumplings, and hamburgers, which correspond to foods or drinks that preferably have richness, fullness, or continuity of taste, in addition to the aforementioned stewed food or drink.

The amount of the flavor improving agent of the present invention to be added to a stewed food or drink differs depending on the stewed food or drink. However, for example, the amount is 0.01 to 10 parts by weight relative to 100 parts by weight of a stewed food or drink.

Examples of the method of improving flavor of the present invention are a method comprising heat-cooking a food or drink material with the addition of amino sugars and a method comprising heating a stewed food or drink product with the addition of amino sugars, in addition to a method comprising using the flavor improving agent of the present invention.

The amount of amino sugar to be added with respect to the total amino acid amount (1 part by weight) in a food or drink material or a stewed food or drink is preferably 0.1 to 100 parts by weight and more preferably 0.1 to 10 parts by weight.

Conditions of heating temperature, pH, and the like are similar to conditions for preparing the flavor improving agent of the present invention.

Examples of the present invention are described below.

### Example 1

A gelatin hydrolysate obtained by heat-treating pig-derived gelatin in the presence of hydrochloric acid (6.8 g) and glucosamine hydrochloride (1.2 g, Kyowa Hakko Kogyo Co., Ltd.) were dissolved in water (15 ml). The resultant was adjusted to pH 7 with sodium hydroxide and heated at 110° C. for 6 hours to obtain solution 1.

Then, solution 2 was obtained by carrying out operations similar to those used for the preparation of solution 1, except that heating was not carried out.

6 mol/l hydrochloric acid (7 ml) was added to the gelatin hydrolysate (1 g), followed by heating at 100° C. for 22 hours. The resultant was applied to an amino acid analyzer for calculation of the total amino acid amount. The amount was found to be 456 mg.

Meanwhile, onion, beef, wine, butter, and wheat flour were fried so as to prepare brown roux. Then, salt, pepper, soy sauce, sauce, and the like were mixed with the brown roux, and the mixture was stewed for 1 hour so as to prepare demi-glace sauce.

Sensory evaluation was conducted by 9 panelists to examine the demi-glace sauces obtained by adding solutions 1 and 2 (0.5 g each) to the above demi-glace sauce (100 g) respectively and a control demi-glace sauce to which solutions 1 and 2 had not been added, in terms of each of the criteria listed in Table 1.

Table 1 shows the average of the evaluation results from the individual panelists.

In addition, symbols used in Table 1 represent evaluation results described below.

---: Significantly weaker than control
--: Weaker than control
-: Slightly weaker than control
±: Comparable to control
+: Slightly stronger than control
++: Stronger than control
+++: Significantly stronger than control

TABLE 1

| | | | Continuity | |
|---|---|---|---|---|
| | Richness | Fullness | of taste | Preferability |
| Non-added (control) | ± | ± | ± | ± |
| Solution 1 added | ++ | ++ | ++ | ++ |
| Solution 2 added | + | + | + | + |

As shown in Table 1, the demi-glace sauce obtained by adding solution 1 that had been obtained by heating gelatin hydrolysate in the presence of glucosamine hydrochloride was superior to the control (non-added) in terms of richness, fullness, and continuity of taste. It was found to be a preferable demi-glace sauce with an enhanced stewed taste.

In addition, when glucosamine hydrochloride (30 mg) was added to the demi-glace sauce prepared above instead of solution 1 or 2, the obtained demi-glace sauce was comparable to the control in terms of each of the criteria listed in Table 1.

Further, demi-glace sauce (stewed for 4 hours) was obtained by operations similar to those used for preparation of the above demi-glace sauce (stewed for 1 hour) except that stewing was carried out for 4 hours. Herein, a time period of 4 hours for stewing corresponds to the time period for obtaining demi-glace sauce with the necessary and sufficient product quality.

Sensory evaluation was conducted by 9 panelists to examine the demi-glace sauce (stewed for 1 hour) to which solution 1 had been added and another demi-glace sauce (stewed for 4 hours) in terms of the stewed taste which is integral of richness, fullness, continuity of taste, etc. and in terms of the preferability as demi-glace sauce. As a result, the stewed taste and the preferred quality of the demi-glace sauce (stewed for 4 hours) were more “strongly” recognized than those of the other demi-glace sauce (stewed for 1 hour). The recognized levels for both criteria were evaluated as substantially comparable.

### Example 2

An isolated soybean protein (100 g, Fuji Pro ME, Fuji Oil Co., Ltd.) was dissolved in water (900 ml). Alcalase (novozymes) was added thereto, followed by reaction at 50° C. for 20 hours and enzyme deactivation at 85° C. to 90° C. The reaction solution was centrifuged and the supernatant was obtained as a hydrolysate of the isolated soybean protein.

The total amino acid amount of the hydrolysate (1 g) of the isolated soybean protein was calculated according to the method described in Example 1. It was found to be 704 mg.

Glucosamine hydrochloride (10 g, Kyowa Hakko Kogyo Co., Ltd.) and water (250 ml) were added to the hydrolysate of the isolated soybean protein (50 g). The resultant was adjusted to pH 8 with sodium hydroxide and heated at 90° C. for 5 hours. The thus obtained solution was subjected to spray drying to obtain powder 1.

In addition, powder 2 was obtained by similar operations, except that glucosamine hydrochloride was not used.

Further, consomme soup was prepared by adding hot water to a consomme cube (15 g) containing sodium chloride, caster (superfine) sugar, beef extract, onion extract powder, sodium glutamate, and lactose so as to result in a total amount of 1 L.

Powders 1 and 2 (1 g each) were added to the consomme soup prepared above (1 L), respectively. Consomme soup to which powders 1 and 2 had not been added was designated as a control. Sensory evaluation was conducted by 9 panelists to examine the stewed taste which is integral of richness, fullness, continuity of taste, etc. and preferability as consomme soup.

Table 2 shows the average of the evaluation results from the individual panelists. Symbols used are the same as those used in Table 1.

TABLE 2

| | Stewed taste | Preferability |
|---|---|---|
| Non-added (control) | ± | ± |
| Powder 1 added | ++ | ++ |
| Powder 2 added | + | ± |

As shown in Table 2, the consomme soup obtained by adding powder 1 that had been obtained by heating the hydrolysate of the isolated soybean protein in the presence of glucosamine hydrochloride had a significantly stronger stewed taste than that of the control.

In addition, when glucosamine hydrochloride (160 mg) was added instead of consomme soup powders 1 and 2, the obtained consomme soup was found to be comparable to the control in terms of each of the criteria listed in Table 1.

### Example 3

β-lactoglobulin (4 g, Sigma) and glucosamine hydrochloride (1 g, Kyowa Hakko Kogyo Co., Ltd.) were dissolved in water (250 ml). The resultant was adjusted to pH 7 with sodium hydroxide and heated at 125° C. for 6 hours to obtain solution 3.

In addition, solution 4 was obtained by similar operations except that glucosamine hydrochloride was not used.

Further, solution 5 was obtained by similar operations except that 13-lactoglobulin was not used.

Solutions 3 to 5 (25 ml each) were added to the consomme soup (1 L) prepared in Example 2, respectively. Consomme soup to which none of the solutions had been added was designated as a control. Sensory evaluation was conducted by 2 panelists to examine the stewed taste which is integral of richness, fullness, continuity of taste, etc. and preferability as consomme soup.

Table 3 shows the average of the evaluation results from two panelists. Symbols used in Table 3 are the same as those used in Table 1.

TABLE 3

| | Stewed taste | Preferability |
|---|---|---|
| Non-added (control) | ± | ± |
| Solution 3 added | ++ | ++ |
| Solution 4 added | ± | ± |
| Solution 5 added | ± | ± |

As shown in Table 3, consomme soup obtained by adding solution 3 that had been obtained by heating β-lactoglobulin in the presence of glucosamine hydrochloride had a stronger stewed taste than that of the control. Therefore, it was found to be a preferable consomme soup.

### Example 4

Solution 6 was obtained by operations similar to those used for preparation of solution 1 used in Example 1, except that galactosamine hydrochloride (Kishida Chemical Co., Ltd.) was used instead of glucosamine hydrochloride.

Solution 6 and solution 1 prepared in Example 1 (25 ml each) were added to the consomme soup (1 L) prepared in Example 2, respectively. Consomme soup to which neither of the solutions had been added was designated as a control. Sensory evaluation was conducted by 12 panelists to examine the stewed taste which is integral of richness, fullness, continuity of taste, etc. and preferability as consomme soup.

Table 4 shows evaluation results. Symbols used in Table 4 are the same as those used in Table 1.

TABLE 4

| | Stewed taste | Preferability |
|---|---|---|
| Non-added (control) | ± | ± |
| Solution 1 added | ++ | ++ |
| Solution 6 added | ++ | ++ |

As shown in Table 4, each of the consomme soups to which solution 1 that had been obtained by heating gelatin hydrolysate in the presence of glucosamine hydrochloride and solution 6 that had been obtained by heating gelatin hydrolysate in the presence of galactosamine hydrochloride had been added respectively had a significantly stronger stewed taste than that of the control. They were found to be preferable consomme soups.

### Example 5

Beef and onion were fried. Water (600 ml) was added thereto and the resultant was stewed for 30 minutes. Further, commercially available beef stew roux (80 g) and glucosamine hydrochloride (1 g) were added thereto and the resultant was stewed for 30 minutes (90° C. or higher). Thus, beef stew was prepared.

In addition, beef stew (control) was prepared by similar operations, except that glucosamine hydrochloride was not added.

Sensory evaluation was conducted by 14 panelists to examine the beef stews in terms of stewed taste which is integral of richness, fullness, continuity of taste, etc. and preferability as beef stew.

Table 5 shows the average of the evaluation results from the individual panelists. Symbols used in Table 5 are the same as those used in Table 1.

TABLE 5

| | Stewed taste | Preferability |
|---|---|---|
| Non-added (control) | ± | ± |
| Glucosamine added | +++ | +++ |

As shown in Table 5, the heat-cooked beef stew obtained with the addition of glucosamine hydrochloride had a significantly stronger stewed taste than that of the beef stew to which no glucosamine hydrochloride had been added. Thus, it was evaluated as a highly preferable beef stew.

### Example 6

Amino acids (4 g) listed in Table 6 and glucosamine hydrochloride (1 g, Kyowa Hakko Kogyo Co., Ltd.) were dissolved in water (250 ml). The resultant was adjusted to pH 7 with sodium hydroxide or hydrochloric acid and heated at 125° C. for 6 hours. Thus, a solution was obtained.

The above solutions (0.5 g each) were added to the demi-glace sauce prepared (100 g) in Example 1, respectively. Sensory evaluation was conducted by 9 panelists to examine each of the criteria listed in Table 6 with the use of, as a control, the demi-glace sauce to which no solution had been added.

Table 6 shows evaluation results. Symbols used are the same as those used in Table 1.

TABLE 6

| Amino acid | Stewed taste | Preferability |
|---|---|---|
| Non-added (control) | ± | ± |
| Arginine | ++ | ++ |
| Lysine | ++ | ++ |
| Histidine | + | + |
| Glutamic acid | + | + |
| Aspartic acid | ++ | + |
| Glycine | ++ | + |
| Proline | ++ | ++ |

As shown in Table 6, the demi-glace sauce to which a solution that had been obtained by heating amino acids in the presence of glucosamine was added had the stewed taste stronger than that of the control (non-added). Therefore, it was found to be a preferable demi-glace sauce.

### INDUSTRIAL APPLICABILITY

According to the present invention, a flavor improving agent, a stewed food or drink with improved flavor, a method of producing either thereof, and a method of improving flavor can be provided.

1. A method of producing a flavor improving agent, comprising a step of allowing amino acids or peptides and amino sugars to coexist and heating the resultant.

2. The production method according to claim 1, wherein heating is carried out at 90° C. to 150° C. under conditions of pH 6 to 9.

3. A flavor improving agent produced by the method according to claim 1.

4. A stewed food or drink to which the flavor improving agent according to claim 3 has been added.

5. A method of improving the flavor of a stewed food or drink, comprising adding amino sugars to a stewed food or drink containing amino acids or peptides and heating the resultant.

6. The method according to claim 5, wherein the improvement of flavor indicates the enhancement of stewed taste.

7. A method of producing a stewed food or drink, comprising a step of adding amino sugars to a food or drink material containing amino acids or peptides followed by heat cooking.

8. A food or drink produced by the method according to claim 7.

9. A flavor improving agent produced by the method according to claim 2.
